(19) United States
(12) Patent Application Publication
(10) Pub. No.: US 2018/0275403 A1
(43) Pub. Date: Sep. 27, 2018

(54) IMAGE FORMING SYSTEM, IMAGE FORMING APPARATUS, AND NON-TRANSITORY COMPUTER READABLE RECORDING MEDIUM STORING KEY OVERRIDE PROGRAM

(71) Applicant: KYOCERA Document Solutions Inc., Osaka (JP)

(72) Inventor: Naoki Sawa, Osaka (JP)

(73) Assignee: Kyocera Document Solutions

(21) Appl. No.: 15/925,374

(22) Filed: Mar. 19, 2018

(30) Foreign Application Priority Data
Mar. 22, 2017 (JP) 2017-056619

(51) Int. Cl. G02B 27/01; G06F 3/01; H04N 1/327; H04N 1/00

(52) U.S. Cl. CPC G02B 27/017; G06F 3/011; H04N 1/00411; H04N 1/00233; H04N 1/32776

(57) ABSTRACT

An image forming apparatus includes an operation panel that includes an operation key. A mobile terminal apparatus includes an imaging device, a display device, a touch panel, a key detecting unit, and a key command transmitting unit. The key detecting unit displays a photo image taken by the imaging device on the display device, detects an operation key image of the operation key, and determines a displaying position of the operation key image displayed on the display device. Upon detecting a user operation to the display position of the operation key image, the key command transmitting unit transmits a command of a private function to the image forming apparatus, and the private function is associated with the operation key by the mobile terminal apparatus. Upon receiving the command from the mobile terminal apparatus, the image forming apparatus performs the private function.

### CROSS-REFERENCE TO RELATED APPLICATIONS

This application relates to and claims priority rights from Japanese Patent Application No. 2017-056619, filed on Mar. 22, 2017, the entire disclosures of which are hereby incorporated by reference herein.

### BACKGROUND

### 1. Field of the Present Disclosure

The present disclosure relates to an image forming system, an image forming apparatus, and a non-transitory computer readable recording medium storing a key override program.

### 2. Description of the Related Art

A system includes an operation-and-display device and a head mounted display (HMD) device. In this system, so as to make a virtual operation screen seen over an operation screen displayed on the operation-and-display device, the virtual operation screen is displayed in the HMD device on an Augmented Reality basis for inputting setting that requires information security.

An image forming apparatus available for plural users, such as a printer or a multi function peripheral, includes an input device, and the input device may include a flexible key. Such a flexible key is a key which a user newly assigns a function (i.e. an action performed when pressed down) to and a user is allowed to edit such an assigned function of.

However, when a user wants to use the flexible key, the user can use the flexible for a specific function only (a) after the user logs-in the image forming apparatus and this logging-in user finds out that the specific function is assigned to the flexible key or (b) after the user logs-in the image forming apparatus after pressing down the flexible key. Thus, the user is required to login the image forming apparatus so that the user effectively uses the flexible key, and consequently, the user is required to perform complicated operations.

### SUMMARY

An image forming system according to an aspect of the present disclosure includes an image forming apparatus, and a mobile terminal apparatus capable of communicating with the image forming apparatus. The image forming apparatus includes an operation panel that includes an operation key, a controller, and a key command processing unit. The mobile terminal apparatus includes an imaging device, a display device, a touch panel, a key detecting unit, and a key command transmitting unit. The key detecting unit displays a photo image taken by the imaging device on the display device, detects an operation key image of the operation key, and determines a displaying position of the operation key image displayed on the display device. The key command transmitting unit detects a user operation to the display position of the operation key image, and upon detecting the user operation, transmits a command of a private function to the image forming apparatus, and the private function is associated with the operation key by the mobile terminal apparatus. The key command processing unit receives the command from the mobile terminal apparatus, and upon receiving the command, causes the controller to perform the private function.

An image forming apparatus capable of communicating with a mobile terminal apparatus, according to an aspect of the present disclosure, includes an operation panel that comprises an operation key; a controller; and a key command processing unit. The key command processing unit receives a command of a private function from the mobile terminal apparatus. The private function is associated with the operation key by the mobile terminal apparatus. Upon receiving the command, the key command processing unit causes the controller to perform the private function.

A non-transitory computer readable recording medium according to an aspect of the present disclosure stores a key override program. The key override program causes a computer in a mobile terminal apparatus to act as a key detecting unit, and a key command transmitting unit. The mobile terminal apparatus capable of communicating an image forming apparatus comprises an imaging device and a display device. The key detecting unit displays a photo image taken by the imaging device on the display device, detects an operation key image of the operation key, and determines a displaying position of the operation key image displayed on the display device. The key command transmitting unit detects a user operation to the display position of the operation key image, and upon detecting the user operation, transmits a command of a private function to the image forming apparatus, and the private function is associated with the operation key by the mobile terminal apparatus, and causes the image forming apparatus to perform the private function.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image forming system in an embodiment of the present disclosure;

FIG. 2 shows a block diagram that indicates a configuration of a mobile terminal apparatus 1 shown in FIG. 1;

FIG. 3 shows a block diagram that indicates a configuration of an image forming apparatus 2 shown in FIG. 1;

FIG. 4 shows a diagram that indicates an example of an operation panel 32 of the image forming apparatus 2 shown in FIGS. 1 and 3;

FIG. 5 shows a diagram that indicates an example of the mobile terminal apparatus 1 that displays a photo image of the operation panel 32 shown in FIG. 4; and

FIG. 6 shows a diagram that indicates an example of the mobile terminal apparatus 1 that displays a photo image of the operation panel 32 shown in FIG. 4 in Embodiment 2.

### DETAILED DESCRIPTION

Hereinafter, embodiments according to an aspect of the present disclosure will be explained with reference to drawings.

### Embodiment 1

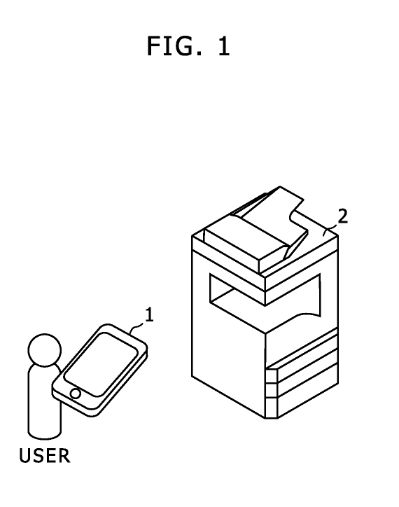

FIG. 1 shows a block diagram that indicates a configuration of an image forming system in an embodiment of the present disclosure. In the system shown in FIG. 1, a mobile terminal apparatus 1 such as a smartphone or a tablet PC is carried by a user who uses an image forming apparatus 2. The mobile terminal apparatus 1 and the image forming apparatus 2 are capable of communicating with each other using wireless communication or the like. In this system, plural users carry plural mobile terminal apparatuses 1, respectively, and each of the plural users can use the image forming apparatus 2 using his/her mobile terminal apparatus 1.

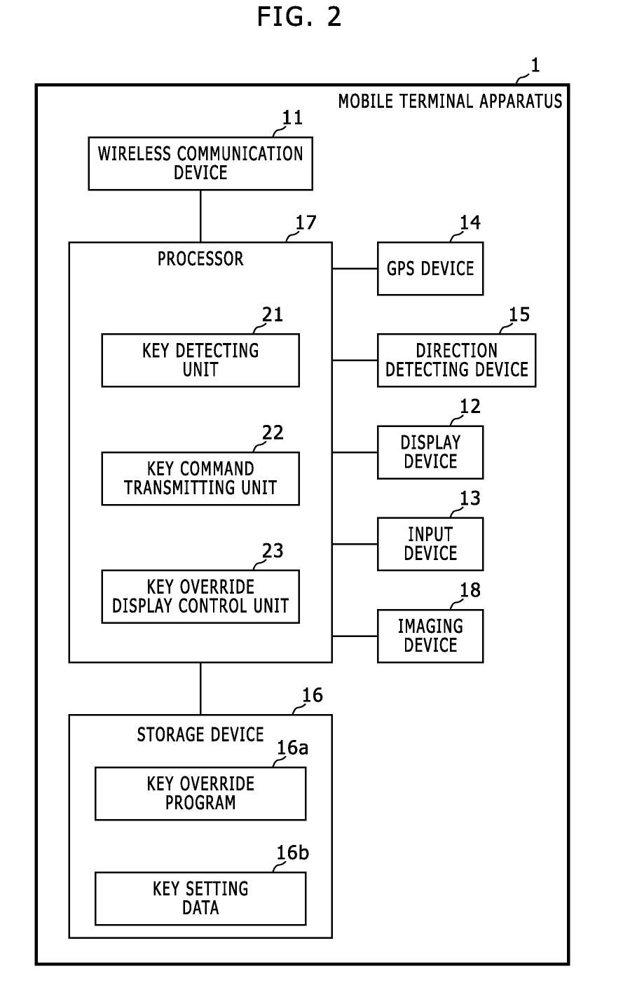

FIG. 2 shows a block diagram that indicates a configuration of a mobile terminal apparatus 1 shown in FIG. 1.

The mobile terminal apparatus 1 includes a wireless communication device 11, a display device 12, an input device 13, a GPS device 14, a direction detecting device 15, a storage device 16, a processor 17, and an imaging device 18.

The wireless communication device 11 is a communication circuit according to a predetermined a wireless communication standard. The wireless communication device 11 is a wireless LAN interface and/or a mobilephone network interface (an RF interface, a baseband unit and the like).

The display device 12 is a device such as a liquid crystal display arranged on a housing of the mobile terminal apparatus 1 and displays sorts of screens to a user.

The input device 13 is a device that detects a user operation, and includes a touch panel arranged on the display device 12, a hard key and the like.

The GPS device 14 is a device that determines an absolute position (latitude, longitude, and altitude) of this GPS device 14, i.e. the mobile terminal apparatus 1 using GPS (Global Positioning System).

The direction detecting device 15 is a device that includes a gyro sensor, an electromagnetic compass or the like and detects a posture (a direction) of the mobile terminal apparatus 1.

The storage device 16 is a nonvolatile storage device such as a flash memory and stores a program and data. The storage device 16 stores a key override program 16a as an application program.

Further, the processor 17 is a computer that includes a CPU (Central Processing Unit), a ROM (Read Only Memory), a RAM (Random Access Memory) and the like, and loads a program to the RAM from the storage device 16, the ROM or the like and executes the program using the CPU and thereby acts as sorts of processing units.

In this embodiment, the processor 17 executes the key override program 16a, and thereby acts as a key detecting unit 21, a key command transmitting unit 22, and a key override display control unit 23.

The key detecting unit 21 displays a photo image taken by the imaging device 18 on the display device 12, detects an operation key image of a specific operation key of the image forming apparatus 2, and determines a displaying position of the operation key image displayed on the display device 12. This operation key of the image forming apparatus 2 may be a hard key or may be a soft key. In addition, this operation key may be a flexible key or an operation key fixedly assigned to a function.

For example, image data of an image of an operation key and its vicinity on an operation panel of the image forming apparatus 2 is registered in key setting data 16b in advance, and the key detecting unit 21 searches the photo image for a characteristic (e.g. a shape of edges or the like) of the operation key and its vicinity specified by the image data registered in the key setting data 16b, and thereby detects an operation key image of the operation key. In this process, for example, shape data of the operation panel may be prepared and stored in the storage device 16 in advance, and a tilting angle of the operation panel in the photo image may be determined on the basis of the shape data, coordinate transformation may be performed to convert an image of the operation panel in the photo image so as to be in an upright status and in a reference size on the basis of the tilting angle. After the conversion, the photo image (i.e. the image of the operation panel) may be searched for a part that having the aforementioned characteristic.

The key command transmitting unit 22 detects a user operation to the display position of the operation key image using a touch panel of the input device 13, and upon detecting the user operation, transmits a command of a private function to the image forming apparatus 2 using the wireless communication device 11. This private function is associated with the operation key by the mobile terminal apparatus 1.

When detecting a user operation to the displaying position of the operation key image, the key command transmitting unit 22 may (a) determine a pressing-down pressure of the user operation using the touch panel of the input device 13, (b) select an option setting value corresponding the pressing-down pressure among plural option setting values specified in the mobile terminal apparatus 1 for the private function, and (c) transmit a command of the private function with the selected option setting value to the image forming apparatus 2, and thereby cause the image forming apparatus 2 to perform the private function under setting specified by the selected option setting value.

For example, when detecting a user operation to an operation key image of COPY function, a pressing-down pressure of the user operation is determined on a real time basis using the touch panel of the input device 13; and by the pressing-down pressure gradually getting larger, option setting values are specified “combination printing of 2 in 1”, “combination printing of 4 in 1”, “combination printing of 4 in 1 and duplex printing”, and “combination printing of 4 in 1, duplex printing and eco printing (‘eco’ means toner save mode)” in this order in turn, an option setting value currently specified is displayed, for example, in a pop-up displaying manner or the like, and an option setting value is finally selected so as to correspond to a pressing-down pressure immediately before the end of this user operation. Therefore, pressing down more strongly restrains more consumption of consumables such as toner and printing paper sheet. In addition, a command (here, a command of the COPY function with a LOGIN function) with the selected option setting value is transmitted to the image forming apparatus 2, and the COPY function is performed under setting specified by this option setting value.

Further, for example, when detecting an user operation to an operation key image of a SEND function, a pressing-down pressure of the user operation is determined on a real time basis using the touch panel of the input device 13; and by the pressing-down pressure gradually getting larger, option setting values are specified “user's own e-mail address for Scan To Email”, “a folder in user's own terminal device e-mail address for Scan To SMB”, “user's own terminal device for Scan To FTP”, and “a group address for Scan To Email” in this order in turn, an option setting value currently specified is displayed, for example, in a pop-up displaying manner or the like, and an option setting value is finally selected so as to correspond to a pressing-down pressure immediately before the end of this user operation. In addition, a command (here, a command of the SEND function with a LOGIN function) with the selected option setting value is transmitted to the image forming apparatus 2, and the SEND function is performed under setting specified by this option setting value.

In the key setting data 16b, a private function specified by a user of this mobile terminal apparatus 1 is described, and the key command transmitting unit 22 reads the key setting data 16b and thereby determines the private function and transmits a command of the determined private function.

If the operation key is a soft key, then the following process may be performed. Operation screen data indicates a key ID and a position of each soft key in an operation screen so as to be associated with a screen ID of the operation screen for each operation screen of the image forming apparatus 2, and the operation screen data is stored in the storage device 16 in advance. The key detecting unit 21 obtains a screen ID of a currently displayed operation screen from the controller 41 of the image forming apparatus 2, and determines a displaying position of a soft key included in an operation screen of the obtained screen ID. The key command transmitting unit 22 detects a user operation to the displaying position of the determined operation key image (i.e. the position of the soft key) using the input device 13, and upon detecting this user operation, transmits to the image forming apparatus 2 using the wireless communication device 11 a command of a private function set correspondingly to a key ID of the soft key in the mobile terminal apparatus 1.

The key override display control unit 23 displays a title of the aforementioned private function on the display device 12 on the operation key image or in its adjacent vicinity on the basis of the displaying position of the operation key image determined by the key detecting unit 21.

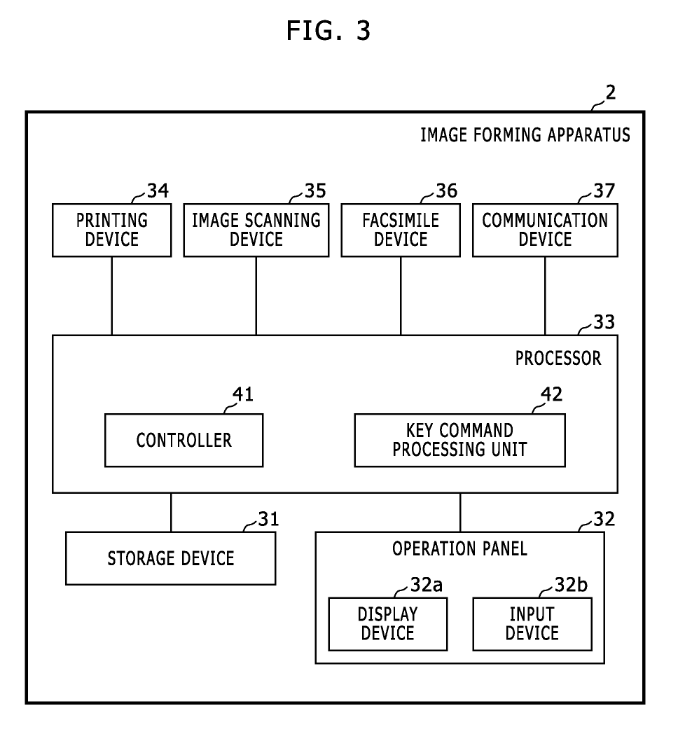

FIG. 3 shows a block diagram that indicates a configuration of an image forming apparatus 2 shown in FIG. 1.

The image forming apparatus 2 shown in FIG. 1 includes a storage device 31, an operation panel 32, a processor 33, a printing device 34, an image scanning device 35, a facsimile device 36, a communication device 37 and the like.

The storage device 31 is a nonvolatile rewritable storage device such as a flash memory.

The operation panel 32 is arranged in a front side on an upper surface of the housing, and includes a display device 32a such as a liquid crystal display and an input device 32b such as a hard key and/or a touch panel. The display device 32a displays sorts of information to a user. A soft key is embodied by the touch panel and a key image displayed on the display device 32a. The input device 32b receives a user operation inputted to a hard key or a soft key by a user.

Further, the processor 33 is a computer that includes a CPU, a ROM, and a RAM, and loads a program to the RAM from the ROM or an unshown storage device and executes the program using the CPU and thereby acts as sorts of processing units. The processor 33 acts as a controller 41 and a key command processing unit 42.

The printing device 34 prints a document image or the like on a printing paper sheet on the basis of image data. Specifically, the printing device 34 outputs a printed matter obtained by printing a document image specified by a print request of a user. Further, the image scanning device 35 optically scans a document image of a document and generates image data of the document image. The facsimile device 36 generates and transmits a facsimile signal of a document image or the like based on image data, and receives a facsimile signal from an external device and generates image data from the received facsimile signal. The communication device 37 is a wired or wireless network interface or the like, and performs data communication with an external device (e.g. the mobile terminal apparatus 1, another host device such as a personal computer, or the like).

The controller 41 controls internal devices such as the printing device 34, the image scanning device 35, the facsimile device 36, and the communication device 37, and thereby performs sorts of processes. For example, the controller 41 receives a printing request, and upon receiving the printing request, causes the printing device 34 to perform printing of a document image specified by the printing request.

The key command processing unit 42 receives the aforementioned command from the mobile terminal apparatus 1 using the communication device 37, and upon receiving the command, causes the controller 41 to perform the private function specified by the received command.

It should be noted that when detecting a user operation to the input device 32b of the operation panel 32, the controller 41 performs a default function set in the image forming apparatus 2. The private function includes both this default function and a specific additional function.

The following part explains a behavior of the aforementioned image forming system.

In the mobile terminal apparatus 1, the key override program 16a is executed, and thereby the key detecting unit 21 displays a photo image taken by the imaging device 18 on the display device 12, and searches the photo image for an operation key image of an operation key registered in the key setting data 16b. In this status, when the operation key enters a visual field of the imaging device 18, the key detecting unit 21 detects an operation key image of the operation key in the photo image.

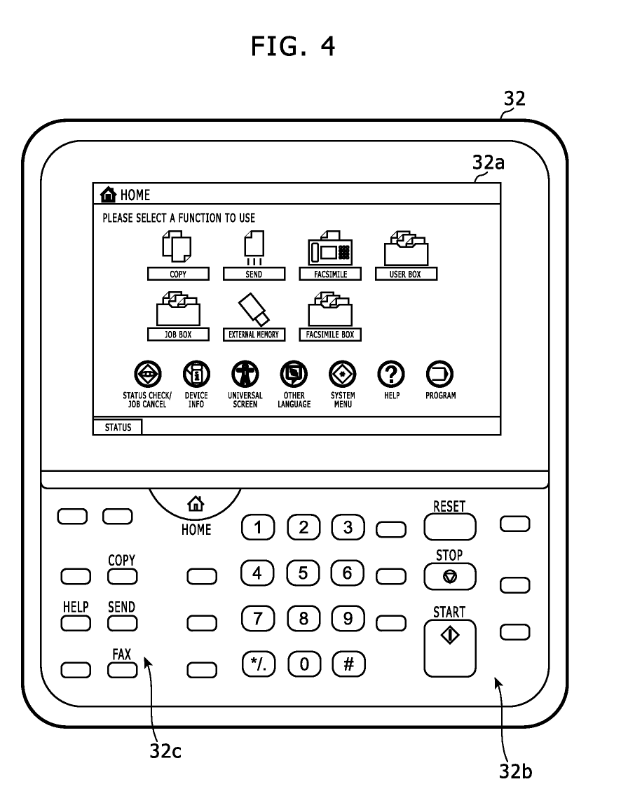

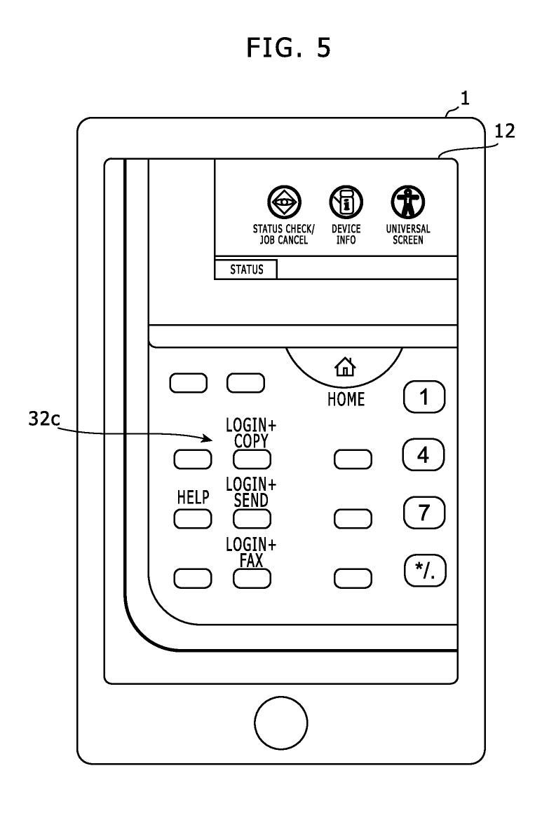

FIG. 4 shows a diagram that indicates an example of an operation panel 32 of the image forming apparatus 2 shown in FIGS. 1 and 3. FIG. 5 shows a diagram that indicates an example of the mobile terminal apparatus 1 that displays a photo image of the operation panel 32 shown in FIG. 4.

For example, in the operation panel 32 as shown in FIG. 4, if (a) three operation keys 32c are registered in the key setting data 16b, (b) default functions of the three operation keys 32c are COPY function (specifically, displaying an operation screen for COPY function), SEND function (specifically, displaying an operation screen for SEND function), and FACSIMILE function (specifically, displaying an operation screen for FACSIMILE function), and (c) private functions for the three operation keys 32c are combination of respective default functions and LOGIN function, then the key detecting unit 21 determines displaying positions of operation key images in the photo image corresponding to these operation keys 32c, and for example, as shown in FIG. 5, the key override display control unit 23 displays on the display unit 12 titles of the aforementioned private functions adjacent to the operation key images, respectively.

The key command transmitting unit 22 detects a user operation to the displaying position of the detected operation key image, and upon detecting the user operation, determines a private function set correspondingly to the detected operation key image in the mobile terminal apparatus 1 on the basis of the key setting data 16b, and transmits a command of the determined private function to the image forming apparatus 2 using the wireless communication device 11.

In the image forming apparatus 2, the key command processing unit 42 receives this command, and upon receiving the command, causes the controller 41 to perform the private function specified by the received command.

In an example shown in FIG. 5, with the command, user authentication information (e.g. a user ID or a pair of a user ID and a password) of a user of the mobile terminal apparatus 1 is transmitted to the image forming apparatus 2, and as a private function, after performing the LOGIN function (i.e. automatic login based on the user authentication information), the COPY function, the SEND function or the FACSIMILE function is performed.

As mentioned, in Embodiment 1, in the mobile terminal apparatus 1, the key detecting unit 21 displays a photo image taken by the imaging device 18 on the display device 12, detects an operation key image of a specific operation key 32c of the image forming apparatus 2, and determines a displaying position of the operation key image displayed on the display device 12, and the key command transmitting unit 22 detects a user operation to the display position of the operation key image using the input device 13, and upon detecting the user operation, transmits a command of a private function to the image forming apparatus 2. This private function is associated with the operation key by the mobile terminal apparatus 1. In the image forming apparatus 2, the key command processing unit 42 receives this command from the mobile terminal apparatus 1, and upon receiving the command, causes the controller 41 to perform the private function specified by the received command.

Consequently, using the mobile terminal apparatus 1, with an easy operation, a user can invoke a specific function assigned to the operation key 32c of the image forming apparatus 2 individually for the user.

### Embodiment 2

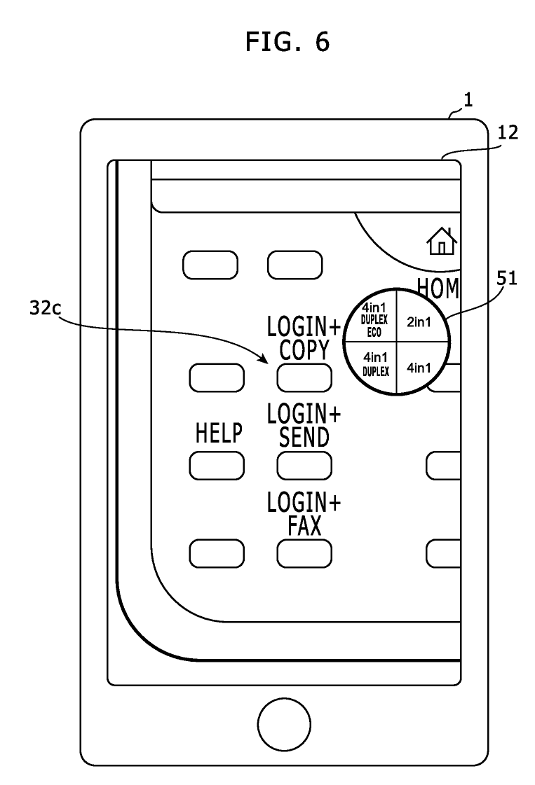

FIG. 6 shows a diagram that indicates an example of the mobile terminal apparatus 1 that displays a photo image of the operation panel 32 shown in FIG. 4 in Embodiment 2.

In Embodiment 2, for example, as shown in FIG. 6, the key detecting unit 21 of the mobile terminal apparatus 1 displays an additional key image 51 on the display device 12 so as to be associated with the aforementioned operation key image. It should be noted that a key corresponding to the additional key image 51 is a virtual key (i.e. a soft key of the mobile terminal apparatus 1) that does not exist on the operation panel 32 of the image forming apparatus 2.

When detecting a user operation to the displaying position of the operation key image of the operation key 32c or a user operation a displaying position of the additional key image 51 using the touch panel of the input device 13, the key command transmitting unit 22 (a) determines a pressing-down pressure of the user operation using the touch panel of the input device 13, (b) selects an option setting value corresponding the pressing-down pressure among plural option setting values corresponding to the additional key image 51 for the private function, and (c) transmits a command of the private function with the selected option setting value to the image forming apparatus 2, and thereby causes the image forming apparatus 2 to perform the private function under setting specified by the selected option setting value.

For example, in an example shown in FIG. 6, the additional key image 51 is displayed for the operation key 32c of COPY function, the additional key image 51 includes a list of option setting values of the COPY function (“combination printing of 2 in 1”, “combination printing of in 1”, “combination printing of 4 in 1 and duplex printing”, and “combination printing of 4 in 1, duplex printing and eco printing”). For example, when detecting a user operation to an operation key image of COPY function or the additional key image 51, a pressing-down pressure of the user operation is determined on a real time basis using the touch panel of the input device 13; and by the pressing-down pressure gradually getting larger, option setting values are specified “combination printing of 2 in 1”, “combination printing of 4 in 1”, “combination printing of 4 in 1 and duplex printing”, and “combination printing of 4 in 1, duplex printing and eco printing” in this order in turn, an option setting value currently specified is highlighted (e.g. changing its displaying color, reversed displaying, or the like) in the additional key image 51, and an option setting value is finally selected so as to correspond to a pressing-down pressure immediately before the end of this user operation. Therefore, pressing down more strongly restrains more consumption of consumables such as toner and printing paper sheet. In addition, a command (here, a command of the COPY function with a LOGIN function) with the selected option setting value is transmitted to the image forming apparatus 2, and the COPY function is performed under setting specified by this option setting value.

Further, for example, an additional key image may be displayed for the operation key 32c of the SEND function. In such a case, for example, the additional key image includes a list of option setting values of the SEND function (“user's own e-mail address for Scan To Email”, “a folder in user's own terminal device e-mail address for Scan To SMB”, “user's own terminal device for Scan To FTP”, and “a group address for Scan To Email”). Further, for example, when detecting an user operation to the operation key image of the SEND function or the additional key image, a pressing-down pressure of the user operation is determined on a real time basis using the touch panel of the input device 13; and by the pressing-down pressure gradually getting larger, option setting values are specified “user's own e-mail address for Scan To Email”, “a folder in user's own terminal device e-mail address for Scan To SMB”, “user's own terminal device for Scan To FTP”, and “a group address for Scan To Email” in this order in turn, an option setting value currently specified is highlighted in the additional key image, and an option setting value is finally selected so as to correspond to a pressing-down pressure immediately before the end of this user operation. In addition, a command (here, a command of the SEND function with a LOGIN function) with the selected option setting value is transmitted to the image forming apparatus 2, and the SEND function is performed under setting (i.e. communication protocol and destination address) specified by this option setting value.

Other parts of the configuration and behaviors of the image forming system in Embodiment 2 are identical or similar to those in Embodiment 1, and therefore not explained here.

As mentioned, in Embodiment 2, the additional key image 51 is displayed and consequently detailed additional setting can be done together.

### Embodiment 3

In Embodiment 3, when detecting a user operation to the displaying position of the operation key image using the input device 13, the key command transmitting unit 22 (a) determines a direction of the mobile terminal apparatus 1 using the direction detecting device 15, (b) selects an option setting value corresponding the determined direction among plural option setting values specified in the mobile terminal apparatus 1 for the private function, and (c) transmits a command of the private function with the selected option setting value to the image forming apparatus 2, and thereby causes the image forming apparatus 2 to perform the private function under setting specified by the selected option setting value.

For example, when detecting a user operation to the operation key image of the COPY function, a current direction of the mobile terminal apparatus 1 is determined; and if the direction (i.e. a tilting angle from a upright status) is 90 degrees to the left, then the option setting value is set as “nothing”, if the direction is the upright direction (i.e. the tilting angle of 0 degree), then the option setting value is set as “combination printing of 4 in 1”, if the direction is 45 degrees to the right, then the option setting value is set as “combination printing of 4 in 1 and duplex printing”, and if the direction is 90 degrees to the right, then the option setting value is set as “combination printing of 4 in 1, duplex printing and eco printing”. For example, the option setting value specified by a current tilting angle may be displayed in a pop-up displaying manner or the like.

Other parts of the configuration and behaviors of the image forming system in Embodiment 3 are identical or similar to those in Embodiment 1 or 2, and therefore not explained here.

In addition, the option setting value may be selected on the basis of both of the direction of the mobile terminal apparatus 1 and the pressing-down pressure described in Embodiment 1 or 2.

For example, (a) when detecting a user operation to the operation key image of the SEND function, if the direction is 90 degrees to the left and the pressing-down pressure is the second level of 5 levels, then “combination printing of 2 in 1” is selected as the option setting value of the SEND function, (b) when detecting a user operation to the operation key image of the FACSIMILE function, if the direction is the upright direction and the pressing-down pressure is the third level of 5 levels, then “combination printing of 4 in 1” is selected as the option setting value of the FACSIMILE function, and (c) when detecting a user operation to the operation key image of the COPY function, if the direction is 90 degrees to the right and the pressing-down pressure is the fifth level (the largest level) of 5 levels, then “combination printing of 4 in 1 and duplex printing” is selected as the option setting value of the COPY function.

As mentioned, in Embodiment 3, by adjusting a direction of the mobile terminal apparatus 1, detailed additional setting can be done together.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned Embodiment 1, 2 or 3, the key override program 16a may be stored in a non-transitory computer readable recording medium. In such a case, the key override program 16a is installed from the recording medium to the storage device 16.

Further, in the aforementioned Embodiment 1, 2 or 3, in order to explain the private function and the option function, a help or guidance may be displayed so as to be associated with the aforementioned operation key image or the additional key image.

Furthermore, in the aforementioned Embodiment 1, 2 or 3, the image forming apparatus 2 may transmit a beacon radio wave with a constant time interval, and when a user who carries the mobile terminal apparatus 1 enters a receivable area of the beacon radio wave (i.e. approaches the image forming apparatus 2), upon receiving the beacon radio wave, the mobile terminal apparatus 1 may automatically start the aforementioned key override program 16a. Consequently, a user is not required to perform an operation to manually start the key override program 16a.

What is claimed is:

1. An image forming system, comprising:
an image forming apparatus; and
a mobile terminal apparatus capable of communicating with the image forming apparatus;
wherein the image forming apparatus comprises an operation panel that comprises an operation key, a controller, and a key command processing unit;
the mobile terminal apparatus comprises an imaging device, a display device, a touch panel, a key detecting unit, and a key command transmitting unit;
the key detecting unit displays a photo image taken by the imaging device on the display device, detects an operation key image of the operation key, and determines a displaying position of the operation key image displayed on the display device;
the key command transmitting unit detects a user operation to the display position of the operation key image, and upon detecting the user operation, transmits a command of a private function to the image forming apparatus, and the private function is associated with the operation key by the mobile terminal apparatus; and
the key command processing unit receives the command from the mobile terminal apparatus, and upon receiving the command, causes the controller to perform the private function.

2. An image forming apparatus capable of communicating with a mobile terminal apparatus, comprising:
an operation panel that comprises an operation key;
a controller; and
a key command processing unit;
wherein the key command processing unit receives a command of a private function from the mobile terminal apparatus;
the private function is associated with the operation key by the mobile terminal apparatus;
upon receiving the command, the key command processing unit causes the controller to perform the private function.

3. The image forming apparatus according to claim 2, wherein the controller detects a user operation to the operation panel, and upon detecting the user operation, performs a default function set in the image forming apparatus; and
the private function includes the default function and a specific additional function.

4. A non-transitory computer readable recording medium storing a key override program, wherein the key override program causes a computer in a mobile terminal apparatus to act as a key detecting unit, and a key command transmitting unit;
the mobile terminal apparatus capable of communicating an image forming apparatus comprises an imaging device and a display device;
the key detecting unit displays a photo image taken by the imaging device on the display device, detects an operation key image of the operation key, and determines a displaying position of the operation key image displayed on the display device; and
the key command transmitting unit detects a user operation to the display position of the operation key image, and upon detecting the user operation, transmits a command of a private function to the image forming apparatus, and the private function is associated with the operation key by the mobile terminal apparatus, and causes the image forming apparatus to perform the private function.

5. The non-transitory computer readable recording medium according to claim 4, wherein when detecting a user operation to the displaying position of the operation key image, the key command transmitting unit (a) determines a pressing-down pressure of the user operation using the touch panel, (b) selects an option setting value corresponding the pressing-down pressure among plural option setting values for the private function, and (c) transmits a command of the private function with the selected option setting value to the image forming apparatus, and causes the image forming apparatus to perform the private function under setting specified by the selected option setting value.

6. The non-transitory computer readable recording medium according to claim 4, wherein the key detecting unit displays an additional key image associated with the operation key image on the display device; and
when detecting a user operation to the displaying position of the operation key image or a user operation a displaying position of the additional key image, the key command transmitting unit (a) determines a pressing-down pressure of the user operation using the touch panel, (b) selects an option setting value corresponding the pressing-down pressure among plural option setting values corresponding to the additional key image for the private function, and (c) transmits a command of the private function with the selected option setting value to the image forming apparatus, and causes the image forming apparatus to perform the private function under setting specified by the selected option setting value.

7. The non-transitory computer readable recording medium according to claim 4, wherein the mobile terminal apparatus further comprises a direction detecting device that detects a direction of the mobile terminal apparatus; and
when detecting a user operation to the displaying position of the operation key image, the key command transmitting unit (a) determines a direction of the mobile terminal apparatus using the direction detecting device, (b) selects an option setting value corresponding the direction among plural option setting values for the private function, and (c) transmits a command of the private function with the selected option setting value to the image forming apparatus, and causes the image forming apparatus to perform the private function under setting specified by the selected option setting value.
